(19) United States
(12) Patent Application Publication
(10) Pub. No.: US 2024/0301166 A1
(43) Pub. Date: Sep. 12, 2024

(54) Mint-Based Vehicular Conductive Wiring Insulation

(71) Applicant: Charles Holt, Madison, WI (US)

(72) Inventor: Charles Holt, Madison, WI (US)

(21) Appl. No.: 18/466,209

(22) Filed: Sep. 13, 2023

Related U.S. Application Data
(60) Provisional application No. 63/492,509, filed on Mar. 8, 2023.

(51) Int. Cl. C08K 5/00; C08L 27/06; C08L 75/04; H01B 3/30; H01B 3/44

(52) U.S. Cl. CPC C08K 5/0058; C08L 27/06; C08L 75/04; H01B 3/302; H01B 3/443

(57) ABSTRACT

A mint-based vehicular conductive wiring insulation for preventing rodents and other animals from chewing vehicular conductive wiring. The insulation is biodegradable and cost-effective and does not contain soy and petrochemical compounds. The insulation includes mint such as Peppermint, Spearmint, and/or Applemint and can be used as an insulation for any type of vehicular electric wiring. The mint wires having mint insulation over a conducting element resembling and functioning like soy-based wires and preventing animals from chewing on the wires due to the repellant properties of mint flavors to most animals. The insulation and wire can be used with any type of wire harness.

### CROSS-REFERENCE TO RELATED APPLICATION

The present application claims priority to, and the benefit of, U.S. Provisional Application No. 63/492,509, which was filed on Mar. 28, 2023 and is incorporated herein by reference in its entirety.

### FIELD OF THE INVENTION

The present invention generally relates to the field of electric wire insulation. More specifically, the present invention relates to a novel mint-based insulation for vehicular conductive wiring. The mint-based insulation is designed to replace soy-based wiring to act as a deterrent for rodents and other animals. The insulation can be made using Mentha x piperita, Mentha spicata, and Mentha suaveolens for providing scent and flavor of mint. The insulation can be designed in multiple colors and sizes for meeting requirements of different vehicle manufacturers. Accordingly, the present disclosure makes specific reference thereto. Nonetheless, it is to be appreciated that aspects of the present invention are also equally applicable to others like applications, devices, and methods of manufacture.

### BACKGROUND

By way of background, automobile manufacturers used petroleum-based wiring insulations prior to 2000. Thereafter, with advancements in technology, most car companies started using soy-based wire insulation. This soy-based wire insulation was also developed due to increasing environmental concerns of petroleum-based insulation, cost-effectiveness, and regulatory requirements.

Generally, soy-based wire insulation is made from a mixture of soybean oil and other plant-based materials. Soy-based insulation is biodegradable, renewable, and more environmentally friendly. It also has lower toxicity compared to petroleum-based materials and releases fewer harmful chemicals during production and disposal.

However, soy-based wire insulation attracts rodents, particularly mice, rats, and other small animals. The scent of soy attracts rodents which can lead to chewing on the vehicle wiring, leading to damage and potential malfunctioning of various electrical systems. Damage to insulation of the wires of vehicles can expose the underlying conductive material, leading to short circuits, electrical malfunctions, and potentially even fires. It is not only difficult to identify such damages but when identified, require vehicle owners to go to service shops for professional help and the cost of repairing or replacing the affected wiring can be huge.

Vehicle owners normally use rodent repellents or additional physical barriers around vulnerable wiring areas to mitigate rodent damage. Some people use rodent-proof garages or other deterrents. But conventional methods are not only ineffective but require repeat implementation which is inconvenient for people. Individuals require an effective way to protect vehicular conductive wiring from rodents and other animals.

Therefore, there exists a long felt need in the art for an improved vehicular conductive wiring insulation. There is also a long felt need in the art for vehicular conductive wiring insulation that prevents damage to vehicular conductive wiring due to rodents and other animals. Additionally, there is a long felt need in the art for vehicular conductive wiring insulation that does not attract rodents and other animals. Moreover, there is a long felt need in the art for vehicular conductive wiring insulation that is not made of soy. Further, there is a long felt need in the art for vehicular conductive wiring insulation that is made of mint whose flavor and smell act as a deterrent for the rodents. Finally, there is a long felt need in the art for mint-based wire insulation for vehicles which is capable of deterring rodents and animals.

The subject matter disclosed and claimed herein, in one embodiment thereof, comprises a mint-based wiring insulation for vehicles. The insulation is designed to replace soy-based wiring insulation. The insulation comprises of mint oil and extracts including oil from at least one peppermint, spearmint, and applemint. The insulation further includes polyvinylchloride as a polymer to form a polymer matrix wherein the insulation can be extruded in different shapes and sizes and the insulation has an exterior color denoting a specific temperature range, the insulation is designed to be coated on a metal wire for insulating the metal wire. The insulation can withstand temperatures in the range from 20° C. to 105° C.

In this manner, the mint-based vehicular conductive wiring of the present invention accomplishes all of the forgoing objectives and provides users with a mint-based wire insulation designed to deter rodents and other animals from chewing on and damaging vehicular conductive wiring. The flavor and scent of mint act as a deterrent for the rodents and animals and thus prevents damage to vehicular conductive wiring due to rodents and other animals. The vehicular wires resemble and function like soy-based wires but comprise a mint ingredient, additive, and/or component.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mint-based vehicular conductive wiring insulation. The insulation comprises of mint oil including oil from at least one of peppermint, spearmint, and applemint, the insulation further includes polyvinyl chloride (PVC) wherein the insulation can be extruded in different shapes and sizes and the insulation has an exterior color denoting a specific temperature range, the insulation is designed to be coated on a metal wire for insulating the metal wire.

In yet another embodiment, a method of insulating vehicular conductive wiring is disclosed and comprises the steps of coating a vehicular metal wire with a mint-based insulation, the insulation comprising: 30-32% polyurethane, 35-40% Peppermint, 30-40% Polyvinyl chloride, and 5-15% Applemint, wherein the coating includes removing moisture from the insulation and extruding the wiring with the insulation.

In a further embodiment of the present invention, a mint-based wiring insulation for manufacturing mint-based vehicular conductive wiring comprises, 30-60% Polyurethane, 25-30% Peppermint, 40-50% Spearmint, and 2-5% hydroxyl, wherein the Peppermint and the Spearmint can be produced from natural plants or commercially using a chemical process.

The insulation of the present invention does not attract rodents and other animals and can be used with any wire harness.

In a further embodiment, a mint-based vehicular conductive wiring is disclosed. The wiring does not attract rodents (i.e., deters rodents) and other animals and includes an inner metal conductor, an outer mint-based insulation coating.

The advantage of the mint-based insulation of the present invention is that it is made of organic and biodegradable materials and is cost-effective. The insulation can be used with different types of vehicular wires and provides effective insulation. The insulation acts as a deterrent for rodents and other animals, thereby preventing chewing of the wires. This protects the vehicle from electrical damage and is cost-effective for vehicle owners.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a flow chart depicting a process of manufacturing of the mint-based vehicular conductive wiring insulation of the present invention in accordance with the disclosed architecture;

FIG. 2 illustrates a flow diagram depicting a process of making mint-based wiring for vehicles in accordance with the disclosed architecture;

FIG. 3 illustrates a perspective view of one potential embodiment of the mint-based wire in accordance with the disclosed architecture; and

FIG. 4 illustrates another embodiment of the mint wire of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved vehicular conductive wiring insulation. There is also a long felt need in the art for vehicular conductive wiring insulation that prevents damage to vehicular conductive wiring due to rodents and other animals. Additionally, there is a long felt need in the art for vehicular conductive wiring insulation that does not attract rodents and other animals. Moreover, there is a long felt need in the art for vehicular conductive wiring insulation that is not made of soy. Further, there is a long felt need in the art for vehicular conductive wiring insulation that is made of mint whose flavor and smell act as a deterrent for the rodents. Finally, there is a long felt need in the art for mint-based wire insulation for vehicles which is capable of deterring rodents and animals.

The present invention, in one exemplary embodiment, is a method of protecting vehicular conductive wiring from electrical damage is disclosed and comprises the steps of coating an vehicular metal wire with a mint-based insulation, the insulation comprising: 30-32% polyurethane, 35-40% Peppermint, 30-40% Polyvinyl chloride, and 5-15% Applemint, wherein the coating is done by creating a vacuum in the insulation and extruding the wiring with the insulation.

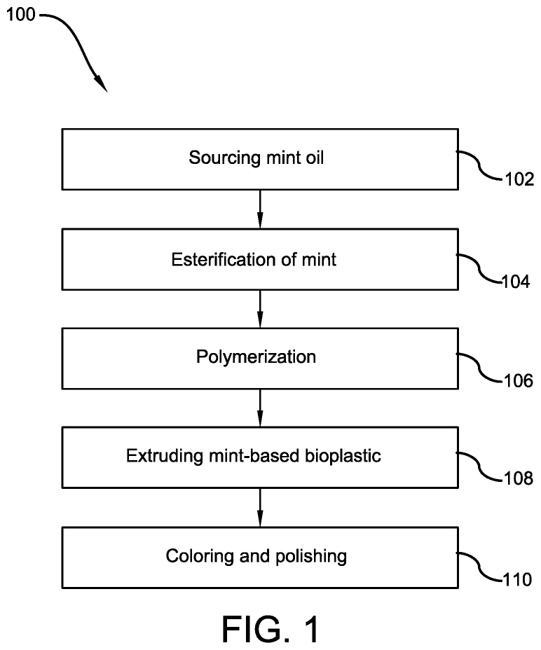

Referring initially to the drawings, FIG. 1 illustrates a flow chart 100 depicting a process of manufacturing of the mint-based vehicular conductive wiring insulation of the present invention in accordance with the disclosed architecture. Initially, natural mint extracts or oils are sourced for manufacturing the wiring insulation (Step 102). The mint flavor and scent can be obtained through extraction from mint plants or synthesized using suitable chemical processes. Mint can be cleaned and crushed to separate the mint oil from the solids. Any conventional method such as a solvent extraction or mechanical pressing can be used for extracting the mint oil.

Then, esterification of the mint oil is performed by using a catalyst (such as hydroxide and hydroxyl of a metal) (Step 104). Thereafter, the combination of the mint oil and the catalyst (forming the ester) is subjected to high pressure which can be in the range from 100 bar to 500 bar and high temperature which can be in the range from 50° C. to 80° C. to form polymer chains of mint (Step 106). It should be noted that the catalyst and environment of the temperature and pressure can vary depending on the required shape and strength of the mint-based wiring insulation.

In the next step 108, the mint-based bioplastic formed in the above step is extruded into different shapes and sizes. Any form of molding or thermoforming can also be used for shaping the mint bioplastic for vehicular conductive wiring insulation. Finally, coloring and polishing is performed on the extruded bioplastic for use as an insulation with vehicular conductive wiring (Step 110). Coloring can be done in different colors to complement the vehicular conductive wiring of a specific brand and logos or other indicia can also be embossed on the mint bioplastic. The mint-based insulation can be coated over any conventional vehicular wire for insulation.

The mint-based wire insulation of the present invention can come in different forms to withstand different temperatures. In some embodiments, different colors denote different temperature ratings. Table 1 below shows one embodiment of different coloring notation of the mint-based wiring insulation.

TABLE 1

| Color | Temperature |
|---|---|
| Black, Orange, Red, Green, Blue, | Up to 80° C. |
| Yellow, Brown & White | |
| Pink & Purple | Up to 105° C. |

The mint-based wire insulation of the present invention can use a polymer matrix for effective polymerization as described in step 106 of FIG. 1. Table 2 below shows one potential composition of mint-based wiring insulation.

TABLE 2

| Component | % age |
|---|---|
| Polyurethane | 30-32 |
| Peppermint (Mentha × piperita) | 35-40 |
| Polyvinyl chloride (PVC) | 30-40 |
| Applemint (Mentha suaveolens) | 5-15 |
| Hydroxyl | To make composition a total of 100 |

Table 3 below shows another potential composition of mint-based wiring insulation.

TABLE 3

| Component | % age |
|---|---|
| Polyurethane | 30-60 |
| Peppermint (Mentha × piperita) | 25-30 |
| Spearmint (Mentha spicata) | 40-50 |
| Metal hydroxyl | 2-5 |

Peppermint has a strong and refreshing aroma which can act as a strong deterrent for rodents and other animals. Spearmint is another common mint variety known for its fresh, slightly sweet flavor. Applemint, also known as round-leafed mint, is a mint variety with a milder flavor.

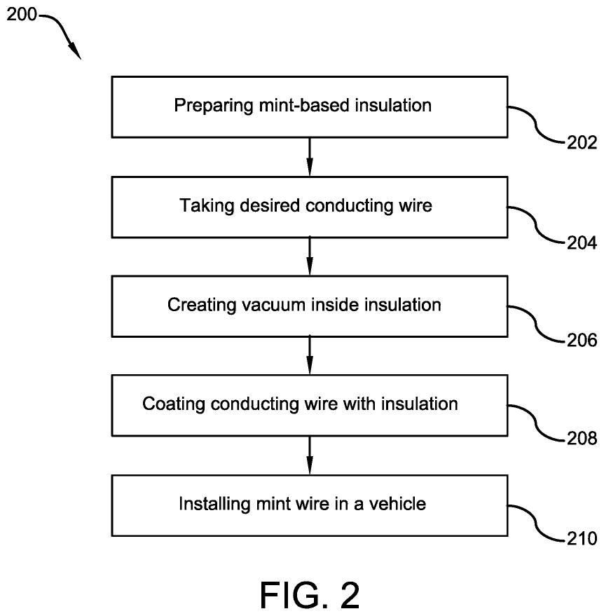

FIG. 2 illustrates a flow diagram depicting a process of making mint-based wiring for vehicles in accordance with the disclosed architecture. Initially, a mint-based insulation is prepared as per the desired mint oil as described in FIG. 1 and Tables 2 and/or 3 (Step 202). Then, a conventional copper or aluminum wire is selected that will be used for vehicular conductive wiring (Step 204). Thereafter, a vacuum is created inside the mint-based insulation using any conventional moisture removing technique (Step 206). Then, the copper or aluminum wire is coated with mint-based insulation for insulating the wire (Step 208). Any conventional extrusion technique can be used for coating the wire. Finally, the mint wire is installed in a vehicle as per requirements based on design of the vehicle (Step 210).

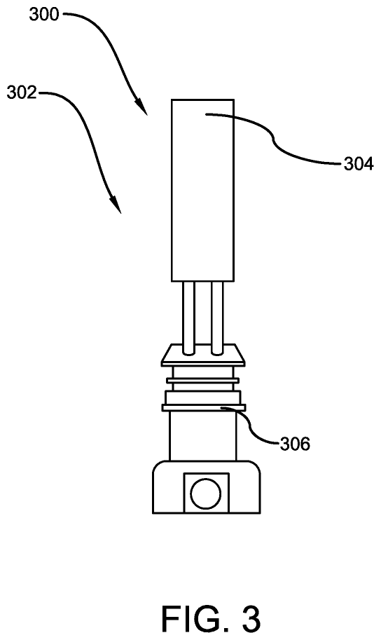

FIG. 3 illustrates a perspective view of one potential embodiment of the mint-based wire in accordance with the disclosed architecture. In the present embodiment, the mint-based wire 302 has an inner conducting metal wire 304 coated with the mint-based insulation 300. The wire 302 can have a wire harness 306 for connecting the wire 302 to any electric port or electronic control unit (ECU) of the vehicle.

The return loss of the mint-wire 302 in different embodiments of the present invention can be in the range of 15 dB to 30 dB and can have any other value depending on the electric circuit of the vehicle.

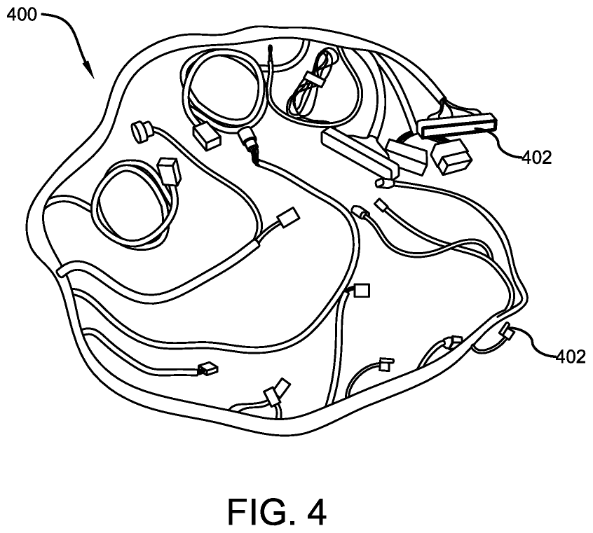

FIG. 4 illustrates another embodiment of the mint wire of the present invention in accordance with the disclosed architecture. In the present embodiment, the wire 400 has a plurality of different connectors 402 which can be electrically molded to the wire 400.

Certain terms are used throughout the following description and claims to refer to particular features or components. As one skilled in the art will appreciate, different people may refer to the same feature or component by different names. This document does not intend to distinguish between components or features that differ in name but not structure or function. As used herein “mint wire”, “wire”, “mint-based wire”, and “mint vehicular conductive wiring” are interchangeable and refer to the mint-based vehicular conductive wiring 302, 400 of the present invention. Similarly, as used herein “mint-based wire insulation”, “mint-based vehicular conductive wiring insulation”, and “vehicular conductive wiring insulation” are interchangeable and refer to the mint-based vehicular conductive wiring insulation 300 of the present invention.

Notwithstanding the forgoing, the mint vehicular conductive wiring 302, 400 and the mint-based vehicular conductive wiring insulation 300 of the present invention can be of any suitable size and configuration as is known in the art without affecting the overall concept of the invention, provided that it accomplishes the above stated objectives. One of ordinary skill in the art will appreciate that the mint vehicular conductive wiring 302, 400 and the mint-based vehicular conductive wiring insulation 300 as shown in the FIGS. 2-3 are for illustrative purposes only, and that many other sizes and shapes of the mint vehicular conductive wiring 302, 400 and the mint-based vehicular conductive wiring insulation 300 are well within the scope of the present disclosure. Although the dimensions of the mint vehicular conductive wiring 302, 400 and the mint-based vehicular conductive wiring insulation 300 are important design parameters for user convenience, the mint vehicular conductive wiring 302, 400 and the mint-based vehicular conductive wiring insulation 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mint-based vehicular conductive wiring insulation comprising:
a vehicular conductive wiring having a vehicular conductive wiring insulation including a mint base for scenting said vehicular conductive wiring insulation;
wherein said mint base extracted from a mint oil;
wherein said mint oil is selected from a group consisting of one or more of a Peppermint oil, a Spearmint oil, and an Applemint oil;
wherein said mint oil processed through esterification using a catalyst;
wherein said mint oil and said catalyst forming an ester;
wherein said ester subjected to a high pressure and a high temperature to form polymer chains of mint;
wherein said polymer chains of mint forming a bioplastic; and
further wherein said bioplastic added to a composition of a polyurethane and a polyvinyl chloride for extrusion into said mint-based said vehicular conductive wiring insulation.

2. The mint-based wiring insulation of claim 1, wherein said mint-based said vehicular conductive wiring insulation coated over said vehicular conductive wiring.

3. The mint-based wiring insulation of claim 2, wherein said high pressure is from 100 bar to 500 bar.

4. The mint-based wiring insulation of claim 3, wherein said high temperature is from 50 degrees C. to 80 degrees C.

5. The mint-based wiring insulation of claim 4, wherein said catalyst is selected from a group consisting of a hydroxide and a hydroxyl of a metal.

6. The mint-based wiring insulation of claim 5, wherein said extracting is a solvent extraction.

7. The mint-based wiring insulation of claim 5, wherein said extracting is a mechanical pressing.

8. The mint-based wiring insulation of claim 1, wherein said composition comprising said polyurethane from 30% to 32% by weight, said peppermint oil from 35% to 40% by weight, said polyvinyl chloride from 30% to 40% by weight, said applemint oil from 5% to 15% by weight, and a remainder of a hydroxyl.

9. The mint-based wiring insulation of claim 1, wherein said composition comprising said polyurethane from 30% to 60% by weight, said peppermint oil from 25% to 30% by weight, said spearmint oil from 40% to 50% by weight, and a metal hydroxyl from 2% to 5% by weight.

10. A method of forming a mint-based vehicular conductive wiring insulation, the method comprising the steps of:
extracting a mint base from a mint oil,
processing said mint oil through esterification using a catalyst, wherein said mint oil and said catalyst forming an ester;
subjecting said ester to a high pressure and a high temperature to form polymer chains of mint;
forming said polymer chains of mint into a bioplastic;
adding said bioplastic to a composition of a polyurethane and a polyvinyl chloride; and
extruding said composition into a mint-based vehicular conductive wiring insulation.

11. The method of forming mint-based wiring insulation of claim 10 further comprising a step of coating vehicular conductive wiring with said mint-based said vehicular conductive wiring insulation.

12. The method of forming mint-based wiring insulation of claim 10, wherein said high pressure is from 100 bar to 500 bar, and further wherein said high temperature is from 50 degrees C. to 80 degrees C.

13. The method of forming mint-based wiring insulation of claim 10, wherein said mint oil is selected from a group consisting of one or more of a Peppermint oil, a Spearmint oil, and an Applemint oil.

14. The method of forming mint-based wiring insulation of claim 10, wherein said catalyst is selected from a group consisting of a hydroxide and a hydroxyl of a metal.

15. The method of forming mint-based wiring insulation of claim 13, wherein said composition comprising said polyurethane from 30% to 32% by weight, said peppermint oil from 35% to 40% by weight, said polyvinyl chloride from 30% to 40% by weight, said applemint oil from 5% to 15% by weight, and a remainder of a hydroxyl.

16. The method of forming mint-based wiring insulation of claim 13, wherein said composition comprising said polyurethane from 30% to 60% by weight, said peppermint oil from 25% to 30% by weight, said spearmint oil from 40% to 50% by weight, and a metal hydroxyl from 2% to 5% by weight.

17. A method of forming a mint-based vehicular conductive wiring, the method comprising the steps of:
extracting a mint base from a mint oil, wherein said mint oil is selected from a group consisting of one or more of a Peppermint oil, a Spearmint oil, and an Applemint oil;
processing said mint oil through esterification using a catalyst, wherein said mint oil and said catalyst forming an ester;
subjecting said ester to a high pressure and a high temperature to form polymer chains of mint;
forming said polymer chains of mint into a bioplastic;
adding said bioplastic to a composition of a polyurethane and a polyvinyl chloride;
extruding said composition into a mint-based vehicular conductive wiring insulation; and
coating vehicular conductive wiring with said mint-based said vehicular conductive wiring insulation.

18. The method of forming mint-based conductive wiring of claim 17, wherein said catalyst is selected from a group consisting of a hydroxide and a hydroxyl of a metal.

19. The method of forming mint-based conductive wiring of claim 17, wherein said composition comprising said polyurethane from 30% to 32% by weight, said peppermint oil from 35% to 40% by weight, said polyvinyl chloride from 30% to 40% by weight, said applemint oil from 5% to 15% by weight, and a remainder of a hydroxyl.

20. The method of forming mint-based conductive wiring of claim 17, wherein said composition comprising said polyurethane from 30% to 60% by weight, said peppermint oil from 25% to 30% by weight, said spearmint oil from 40% to 50% by weight, and a metal hydroxyl from 2% to 5% by weight.
